(19) United States
(12) Patent Application Publication
(10) Pub. No.: US 2004/0178045 A1
(43) Pub. Date: Sep. 16, 2004

(54) Extendible beltline system

(76) Inventor: Robert B. Conner JR., Prestonsburg, KY (US)

Correspondence Address: BIRCH STEWART KOLASCH & BIRCH, PO BOX 747, FALLS CHURCH, VA, 22040-0747, US

(21) Appl. No.: 10/762,367

(22) Filed: Jan. 23, 2004

Related U.S. Application Data
(60) Provisional application No. 60/441,766, filed on Jan. 23, 2003.
(60) Provisional application No. 60/488,410, filed on Jul. 21, 2003.

(51) Int. Cl. B65G 15/26

(52) U.S. Cl. 198/313; 198/812

(57) ABSTRACT

An extendible belt conveyor system for a mine. Cars carrying conveyor rollers are part of a main conveyor. When the conveyor needs to be expanded, the individual cars may be extended to extend the framework for the belt. The wheels on the cars may be both elevated and rotated for positioning. A low profile structure may carry a separate conveyor which can fit below the profile of the cars and thus further extend the conveyor. The low profile conveyor can have an elevating head drive mounted thereon which is slidable and can be fixed in a position as the framework is moved forward. This arrangement can be used also in other situations as for dumping refuse in a pile.

### CROSS REFERENCE TO RELATED APPLICATIONS

The present application is based on Provisional Application 60/441,766 filed Jan. 23, 2003 and 60/488,410 filed Jul. 21, 2003, both of which are incorporated by reference.

### BACKGROUND OF THE INVENTION

1. Field of the Invention

This invention relates to conveyor systems used in mining operations and more particularly to an extendible beltline conveyor system used in mines using mobile cars with elevating and rotatable wheels, and a method for operating such a conveyor system.

2. Description of the Background

In mining operations, the transportation of the mined mineral, such as coal to the surface is a major component of the mining operation. Such systems are well known and often include fixed conveyor sections which are either mounted on the floor of the mine or suspended from the roof of the mine. Unfortunately, the mining operation is not static and accordingly, as the mine face is worked, it is necessary for the conveyor to follow the mining machine as it advances or retreats. This means that the conveyor must somehow be moved or extended to follow the mining machinery. Traditionally, the belt can be extended or retracted by either adding or removing a section of the belt. This is accompanied with the addition or removal of some type of conveyor structure such as rollers and a support structure for holding the rollers. In addition, the tailpiece or final roller on the belt must be moved and anchored. These steps are usually accomplished together. The belt must be stopped in order for the work to be done so that lost production occurs or the movement must be concentrated at a time when work is stopped, such as during a shift change. One way to avoid some of this problem is to have a belt storage unit that can store additional belt length, such as 500 feet of extra belt, in the mechanism while keeping the remaining belt taut. However, these units are large and require a lot of time to set up and take down. While this unit stores additional belt length, it does not provide any additional support structure or rollers, so these must still be installed accompanied with the stoppage of the belt.

U.S. Pat. No. 5,228,549 shows one approach to this situation that allows a beltline to be extended or shortened by using a plurality of cars, with each car having jacks that allow it to be raised to be in line with the existing conveyor belt. Each car carries a roller structure to support the conveyor. When the conveyor needs to be lengthened, the belt is cut and the cars are rolled into position and jacked up to match the level of the existing belt. The belt is then patched where it had been cut, allowing the conveyor to be started again in a relatively short time. If a belt storage unit is used with the cars, cutting and patching the belt is not necessary.

Systems such as these allow the conveyor to be extended relatively quickly. However, it is still necessary for the belt to be stopped while the extension occurs. Also, the cars are best used as a temporary measure and a permanent structure still needs to be installed at a convenient time. While the belt may be shut down for a short time without adverse effects to the mining operations, especially during shift changes or other prescheduled down time, it is preferable that the belt be stopped for as short a time as possible so that mining operations can continue without interruption.

Furthermore, it is desirable that all mining equipment be as mobile as possible so that movement of equipment into position can occur quickly and easily. Moving equipment which is not wheeled is cumbersome and time consuming. Furthermore, placing conveyor rollers or other equipment into position is a difficult, time consuming operation which requires heavy lifting and possible injury. Accordingly, any conveyor system which avoids the necessity to assemble parts and avoids heavy lifting is desirable. While present systems are an improvement over any earlier systems, further advancement in mobility, quick adjustment and reduced manual work is desirable.

### SUMMARY OF THE INVENTION

Accordingly, the present invention provides for an improved extendible conveyor.

The present invention further provides an improved method of operating a conveyor.

The present invention still further provides an improved underground conveyor system which is easily extendible and is adjustable in elevation.

The present invention further provides wheel-elevating assemblies on conveyor sections which both elevate and rotate.

The present invention also provides an underground conveyor beltline system, which is easily moved, and a method of operating the same.

The invention further provides a conveyor system having a slidable head drive which is extendible beyond the conveyor.

The present invention further provides an extendible conveyor system having a sliding head drive which carries a separate conveyor and elevates the load onto the main conveyor.

Briefly, the present invention achieves this by providing a series of mobile cars which may be included in the conveyor system and which are extendible in the longitudinal direction so as to allow the belt to be easily enlarged. Wheels are provided on the cars which not only elevate the car, but which can be rotated so as to maneuver the car into position transversely. The system may be used also in conjunction with a separate low profile conveyor which is low to the ground and can be placed under the main conveyor or mobile car arrangement. The low profile conveyor can then be moved forward to extend the total arrangement. A self-traming head may ride on the structure of the low profile conveyor so as to remain in alignment with the end of the main conveyor.

### BRIEF DESCRIPTION OF THE DRAWINGS

The present invention will become for more fully understood from the detailed description given herein below and the accompanying drawings which are given by way of illustration only and thus are not limitive of the present invention, and wherein:

FIG. 1 is a side view of an extendible car according to a first embodiment of the invention;

FIG. 2 is a side view of the car of FIG. 1 in a tilted position;

FIG. 3 is a side view of the car of FIG. 1 in an extended position;

FIG. 4 is a top view of the car of FIG. 1;

FIG. 5 is a top view of the car of FIG. 1 in an extended position;

FIG. 6 is a side view of a second embodiment of the present invention,

FIG. 7 is a side view of the car of FIG. 6 in an extended position;

FIG. 8 is a side view of the car of FIG. 7 in a tilted position;

FIG. 9 is a perspective view of an elevated wheel assembly for a car of FIG. 1;

FIG. 10 is a perspective view of the wheel assembly of FIG. 9, in a rotated position;

FIG. 11A is a side view of a low profile conveyor structure in accordance with a third embodiment of the present invention;

FIG. 11B is an end view of the low profile structure;

FIG. 11C is an end view of the low profile structure, below a car such as shown in FIG. 1;

FIG. 12 is a side view of a car and low profile conveyor arrangement together;

FIG. 13 is a perspective view of a low profile conveyor having a slidable elevating section according to a fourth embodiment of the present invention;

FIG. 14 is a perspective view of a low profile arrangement in conjunction with a car arrangement;

FIG. 15 is a perspective view of an extendable car and low profile arrangement which are parallel;

FIG. 16 is a perspective view of a conveyor used to remove material below the profile conveyor mounted at the forward end of the main conveyor;

FIG. 17 is a perspective view of the extendible car as shown in FIG. 1;

FIG. 18 is a perspective view of the low profile conveyor of FIG. 13 with the belt installed;

FIG. 19 is a perspective view of the low profile arrangement of FIG. 14 with the belt installed; and

FIG. 20 is a perspective view of the conveyor used to remove material with forward legs.

### DETAILED DESCRIPTION

The scope of the applicability of the present invention will become apparent from the detailed description given hereinafter. However, it should be understood that the detailed description and specific examples while indicating preferred embodiments of the invention, are given by way of illustration only since various changes and modifications within in the spirit and scope of the invention will become apparent to those skilled in the art from this detailed description.

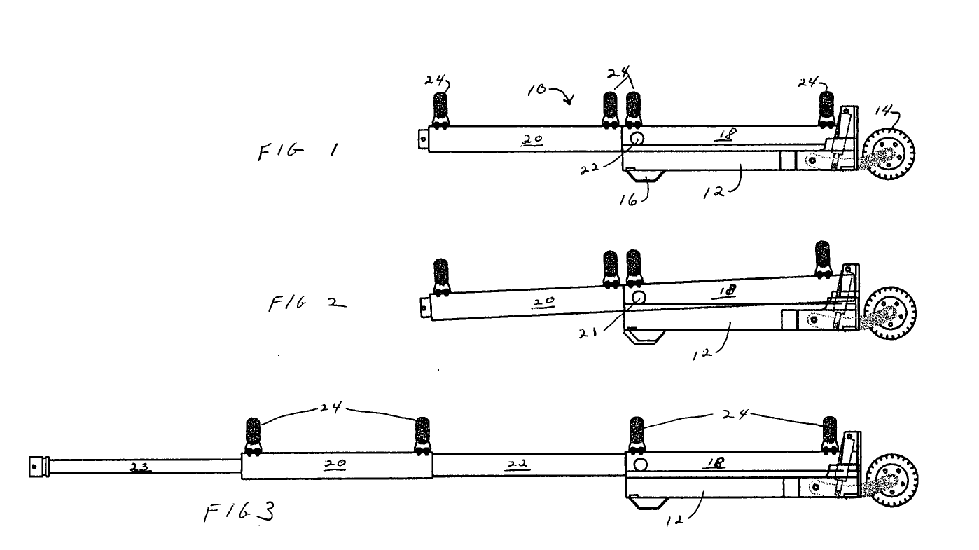

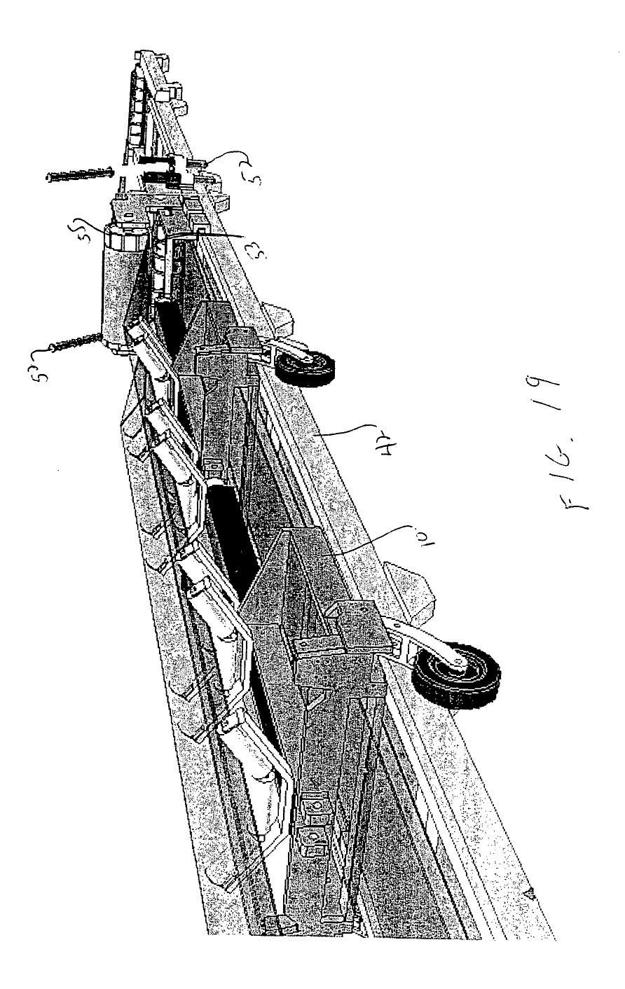

FIG. 1 shows a first embodiment of a mobile car 10 used in a mobile conveyor system. The car includes a frame 12 on which are mounted at one end wheels 14 and at the other end skids 16. The skids keep the end of the frame from digging into the mine floor when moving over an uneven area as well as keep the frame off the floor. Two wheels are normally present at one end and two skids at the other end of the frame. However, it would also be possible to have four wheels, if desired. The wheels may be elevatable using a hydraulic device if desired. The wheeled frame of the car includes a shaft 18, mounted thereon. The shaft 18 extends the same length as the frame 12. A second shaft 20, which is coaxial therewith, extends from the front edge of shaft 18. Each shaft supports a pair of roller sets 24 on which the conveyor belt will be placed. A pivot point 21 is attached to shaft 18 so that the shafts may be pivoted in order to allow for travel over uneven floors. As shown in FIG. 2, the shafts may be pivoted around this point so that the end nearest the wheels may be raised and the end away from the wheels may be lowered. Once in position, the wheels may be elevated to keep the frame and shaft aligned. While shafts 18 and 20 are shown as round in cross section, other shapes such as square bars or even two-dimensional frames may be used. FIG. 17 shows a perspective view of the same arrangement.

Shaft 18 has an extended portion 22 fixedly mounted thereto that is of smaller diameter than shaft 18. Shaft 20 is slidable over shaft 22 and accordingly hides shaft 22 when the car is not extended. Shaft 23 extends forwardly from the front of shaft 20 and is of reduced diameter so that it will slide within shaft 22, which is hollow. Accordingly, shafts 18 and 22 are fixed while shafts 20 and 23 are slidable so as to extend the length of the car. Preferably, the shafts are square in cross-section so that they will not rotate about each other. Shafts 20 and 22 are roughly the same length as shaft 18. Shaft 23 may be slightly shorter. While the shafts are mounted for sliding engagement, they are prevented from moving to the point that they come disengaged from each other. In order to cause the shafts to extend, a hydraulic cylinder may be placed within the shafts. Similarly, other means could be placed therein for causing movement such as an electric motor or various types of mechanical means. It would also be possible for the shafts to allow sliding but without any active means to cause it. Thus, the shafts could be made to extend merely by moving one of the cars while the adjacent car is fixed. It is envisioned that some type of latching mechanism would hold the shafts in their normal position until release is desired.

When the shafts are fully extended, the length of the car is approximately doubled, since each of the shafts is approximately the same length. For example, if the frame 12 is roughly 12 feet long, each of shafts 18, 20 and 22 are of similar length. Shaft 23 may be slight shorter, such as 10 feet long, if necessary. The front end of shaft 23 is normally connected to an adjacent car in a series.

Accordingly, when it is desired to extend the conveyor belt, it is possible to cut or otherwise disconnect the belt itself, extend the shafts on one or more cars and then reattach the belt into a complete loop. This procedure can be accomplished in a relatively short time since it is not necessary to attach mechanical parts. Instead, it is only necessary to disconnect the belt, move the mobile cars after releasing the appropriate latches to cause the shafts to slide and then patch the belt with an extension piece. This is a relatively simple operation and allows for the extension of the belt by a substantial distance roughly equal to the length of the mobile cars utilized. If the conveyor system includes a belt storage device for holding additional belt length, it is not even necessary to follow this procedure. Instead, the car can merely be extended and the additional belt length can readily be taken out of the belt storage device.

Furthermore, although this arrangement could be used for a permanent installation, if desired, a better use of the equipment would be to utilize the extendible cars as a temporary measure to extend the belt line while the mining operation is proceeding. During normal downtime, such as shift changes or other scheduled downtime, it is possible to contract the cars and install permanent structures. The contracted cars can then be used at the forward end of the fixed structure so as to be expandable again when needed. This allows the belt to be extended when desired without stopping the belt and allows the permanent structure to be installed when convenient.

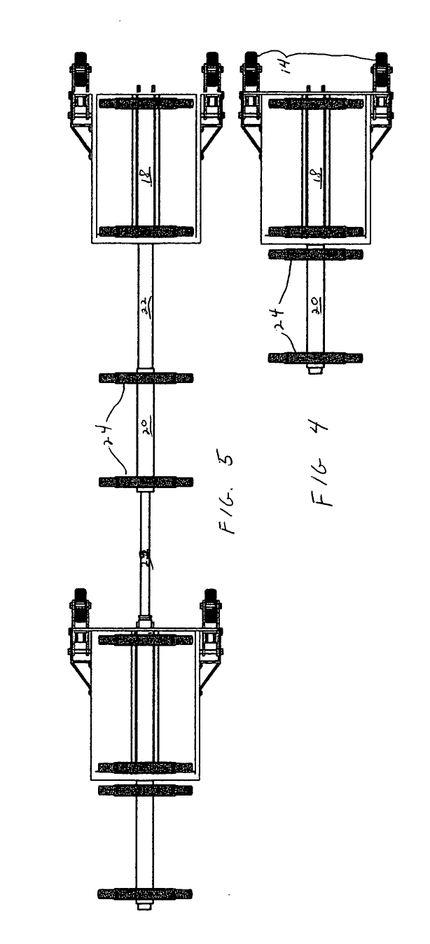

FIG. 4 shows the top view of the car 10 shown in FIG. 1. Likewise, FIG. 5 shows a top view of the car shown in FIG. 3 in the extended position. Note that in FIG. 5 the front end of the additional shaft 23 is connected to the rear of the next car.

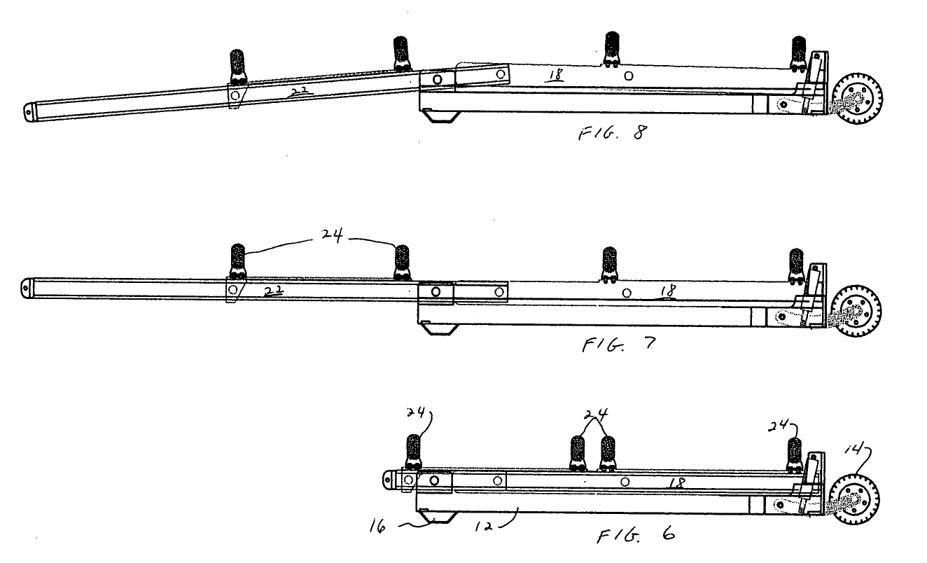

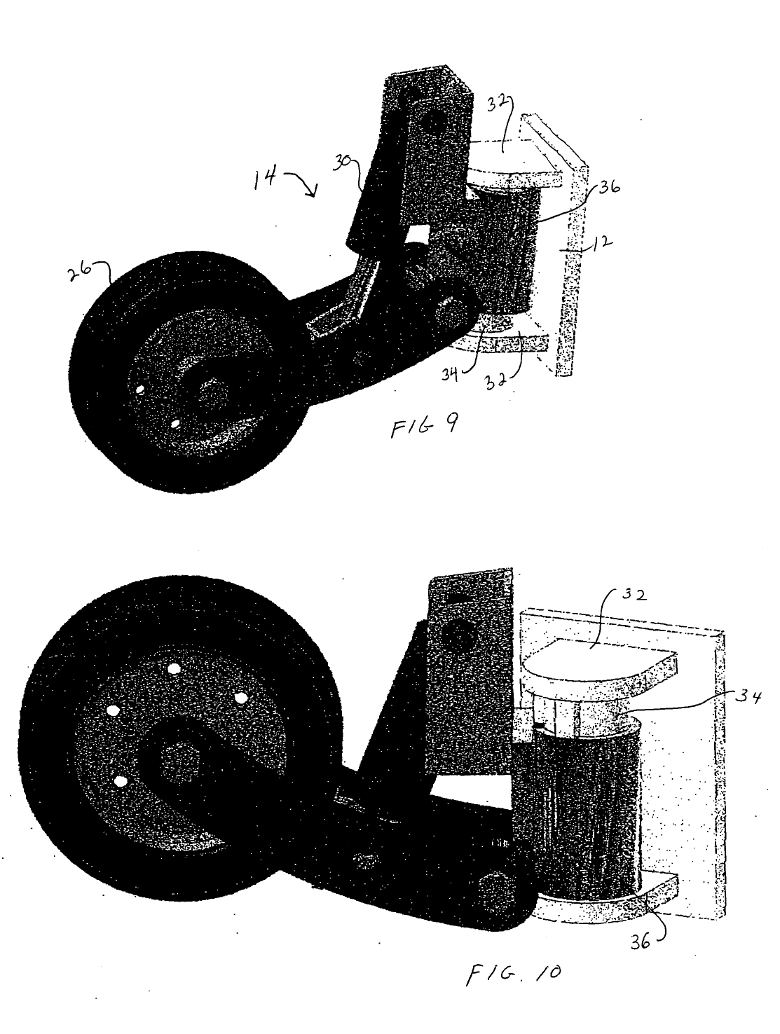

FIGS. 6-8 show a second embodiment of the mobile car. This car includes a similar framework 12 having a wheel at one end and a skid at the other. However, the frame extends the full length of car, as does shaft 18. Shaft 18 includes therein a slidable additional shaft 22 which can be extended in a similar fashion as shown in FIG. 7. However, this additional shaft is roughly the same length as shaft 18 and thus twice the length of the additional shaft shown in FIG. 3. The conveyor rollers 24 in this arrangement are mounted in slightly different positions than in the first embodiment, however, even when extended in this arrangement, the rollers are placed at regular intervals so as to properly support the conveyor belt.

FIG. 8 shows the car of FIG. 7 but where the additional shaft 22 is allowed to pivot to accommodate changes in elevation in a similar fashion to that accomplished in the first embodiment.

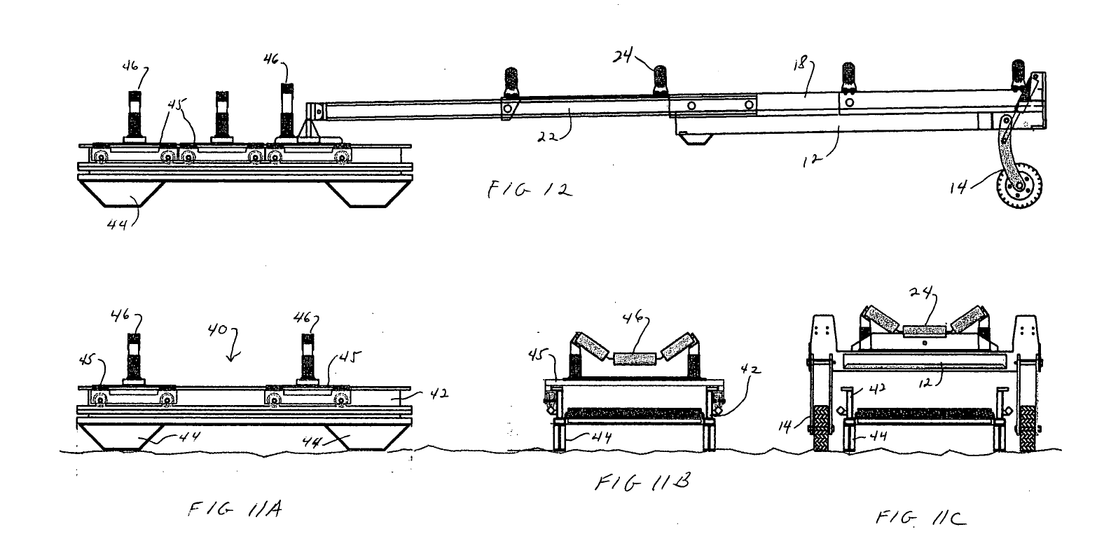

FIG. 9 shows a wheel assembly which may be utilized on the ends of car 10. The wheel assembly 14 is connected to the frame 12 of each car. The assembly includes a wheel 26 mounted on a pivoting support 28 which is fixed at its far end in a pivoting fashion. A hydraulic cylinder 30 is connected to the pivoting shaft near its mid point so that when the cylinder is extended, the pivoting shaft rotates lifting the frame 12 of the car. The frame 12 carries flanges 32 in a fixed fashion, with the flanges being approximately parallel to each other. Vertical shaft 34 extends between the flanges, about which hollow shaft 36 extends.

When it is desired to raise the car, the cylinder is extended causing the pivoting support 28 to rotate and lift the car. When it is desired to move the car sideways, it is possible to rotate the wheel so that hollow shaft 36 rotates around shaft 34. With the wheel approximately 90° from its original position, it is possible to move the car transversely to adjust its position as necessary. If desired, a locking mechanism may be included with the wheel assembly so that the wheel may not be rotated except when desired. This will ensure that the car moves straight when pulled in a forward direction but can be released easily to a second position in order to move the car transversely. The second position of the assembly is shown in FIG. 10.

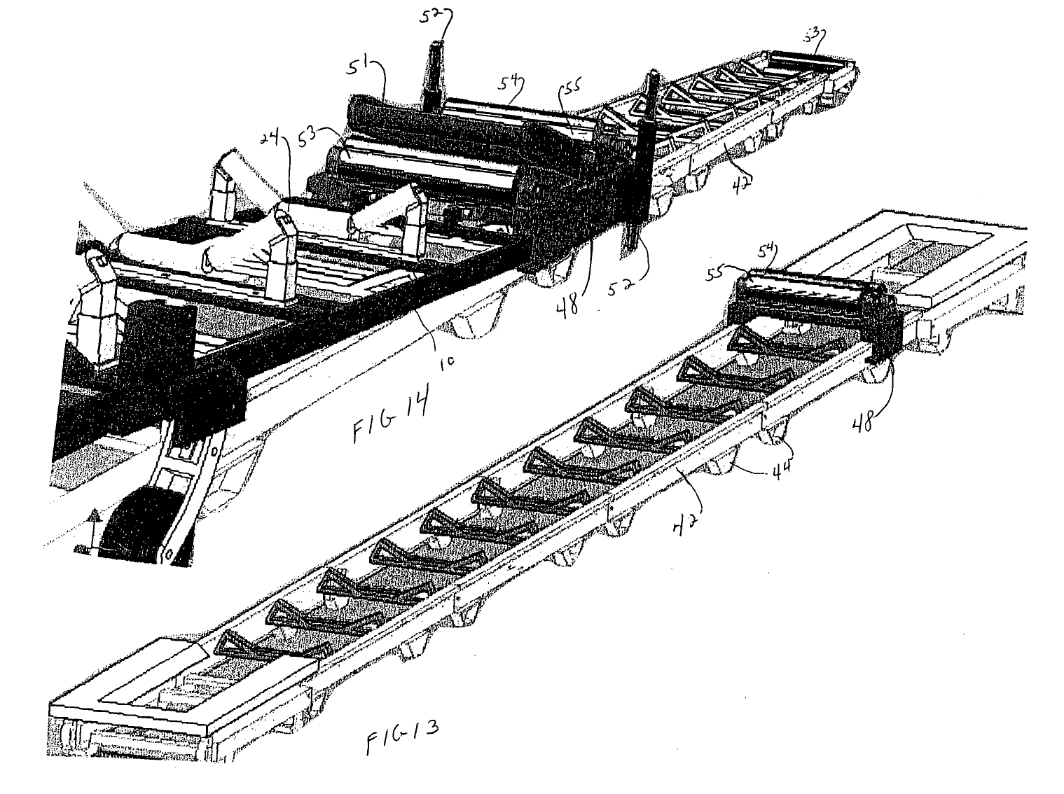

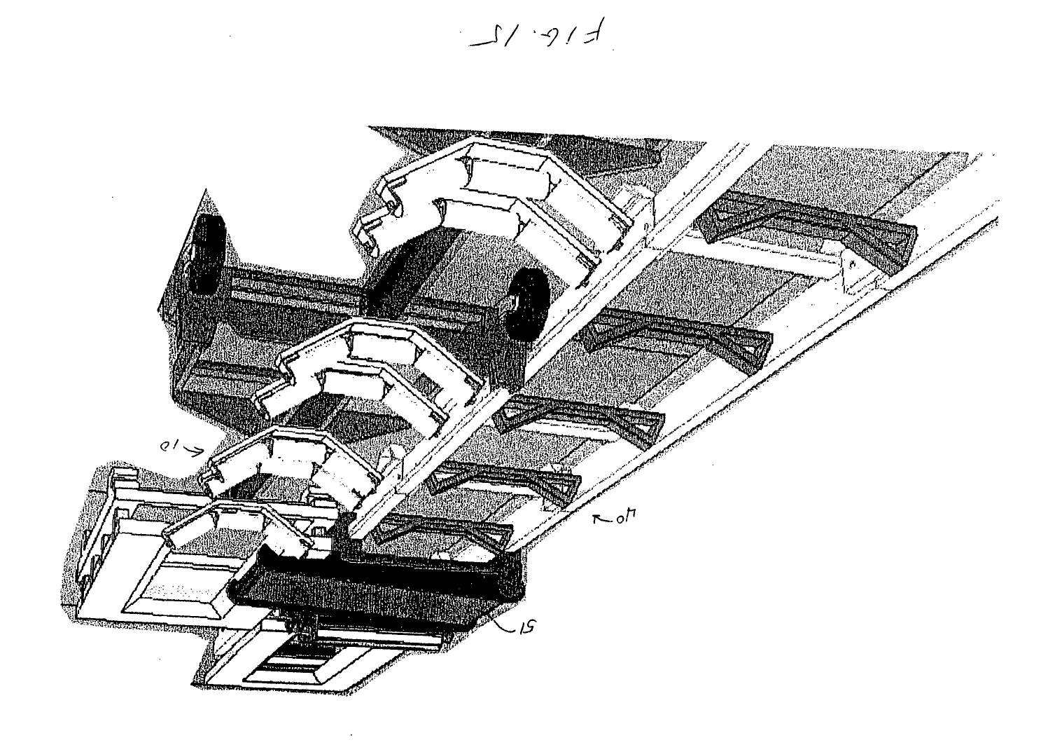

While the system described above allows a quicker and easier expansion of the belt conveyor, an additional improvement can also be obtained when this system is utilized in conjunction with a lower mounted low profile conveyor structure. This type of conveyor is often referred to as a rigged frame structure (RFM) or a Lo Lo structure. Such a structure is shown in FIG. 11A as element 40 in cross section. A framework including side rails 42 are mounted on short skids 44. Wheels or short legs could also replace the skids. However, no matter what structure is used, it must be very short. A series of dollies 45 are mounted so as to roll on the side rails and thus may be adjusted along the length of the framework. Each dolly includes conveyor idler rollers 46 mounted above the surface of the dolly so as to support the conveyor belt. The conveyor belt which is carried by the fixed structure and any of the cars is also carried forwardly on top of the dollies of the Lo Lo structure. The belt returns below the fixed structure and below the Lo Lo framework. Thus, a unitary belt system is employed in this arrangement.

This Lo Lo structure has a profile which is small enough to sit between the wheels of the expanding cars as shown in FIG. 11C. It can be also be used with non-expanding cars. As a result, the forward end of the Lo Lo may be adjacent the mining machine and receive the coal or other minerals as it comes off the mine face and carry them along the conveyor and onto the forward end of the first expanding car or the forward end of the fixed conveyor system. It may be desired for the conveyor belt on the Lo Lo to increase in height as it approaches the forward end of the first expanding car as shown in FIG. 12. This can be accomplished by increasing the height of the dolly nearest the car. Since the profile of the Lo Lo structure can be received below the expanding car, it is possible that a long section of the Lo Lo can be placed under the cars.

Since the dollies are separately movable on the frame of the Lo Lo, it is possible to expand the beltline by moving the dollies forward. Thus, by bunching the dollies together, as shown in FIG. 12, and having most of the length of the Lo Lo beneath the car, a relatively small expansion of the beltline will occur. However, if the dollies are spread further apart as the Lo Lo is pulled forward, such as shown in FIG. 11A, the belt can be extended further. By starting with the length of the Lo Lo extending under the car, as shown in FIG. 11C, and with the dollies bunched at the front end of the car, it is possible to provide large amounts of expansion merely by slowly pulling the framework forward and allowing the dollies to separate to support the longer section of belt. Thus, the belt may be expanded by the length of the frame of the Lo Lo that extends under the car. The additional length of belt may be taken from the belt storage unit, as discussed above, or the belt may be cut and patched for an additional section.

As the mining equipment advances, the Lo Lo structure can be pulled along with it so that an expansion equal to the length of the Lo Lo can be obtained without even expanding the car or with the use of a non-expanding car. However, it is also possible to incorporate the movement of the Lo Lo structure with the expansion of the car so that together an even larger expansion of the belt may occur. It is also possible that the advancing end of the expanding car may control the movement of the dollies so that the dollies are pushed forward to stay out of the way of the forward end of the conveyor.

The Figures show the dollies as having wheels for moving along the side rails. However, the wheels may be replaced by a sliding structure as long as the dollies are movable. The movement may be accomplished under their own power or may be manually moved into position as desired. Locking members may hold the dollies temporarily in the position until another movement is necessary.

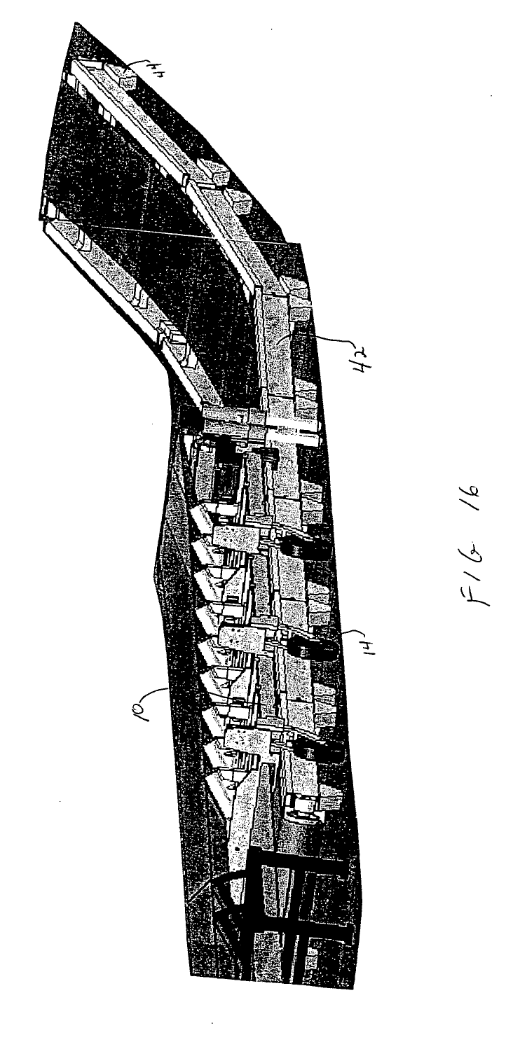

FIGS. 13 and 14 show another arrangement of the Lo Lo structure which may be used with the expanding cars or with a fixed conveyor belt. In both FIGS. 13 and 14, the conveyor belt itself has been removed to better show the operation of the device. As shown in FIG. 13, a framework including side rails 42 and skids 44 are similar to the previous embodiment. However, in place of a dolly, a sliding head drive 48 is mounted on the rails either on wheels or in a sliding relationship to the rails. This head drive may be moved forward or backward either under its own power using a tramming system or by an external power source such as a forward end of the extending car. The head drive carries two of the rollers 54 and 55 over which the Lo Lo conveyor passes. FIG. 18 shows the arrangement of FIG. 13, but with the belt installed.

Typically, the head drive of the Lo Lo contains a mechanism for driving the Lo Lo conveyor belt. The drive may be in the head drive 48 or may be at either end of the frame. The two rollers 54 and 55 are powered to drive the belt. Roller sets are placed along the length of the Lo Lo and are supported by the cross pieces. A tail roller may be placed at each end to reverse the direction of the belt so that the belt forms a single loop. When the belt leaves the front tail roller, it extends along the framework and rises to the top of the rear roller 55 in the head drive which is higher than the front roller. The belt extends around the back side of roller 55 and when it reaches the bottom of this roller, it proceeds forwardly and upwardly onto the top of front roller 54. The belt extends around the front of the front roller until it reaches the bottom of the front roller until it is in line with the rollers on the cross pieces. The two rollers 54 and 55 cause the belt to move by their movement. The head drive unit causes the material on the conveyor to be lifted upwardly so that it can be dumped onto the main conveyor belt. Thus, in this embodiment, the Lo Lo has a separate belt from the main belt on the fixed structure or cars. By lifting the material, it can then fall onto the forward end of the main belt. Since the belt on the Lo Lo is separate from the main belt, when an extension is needed, the framework of the Lo Lo can be pulled forwardly, causing an extension of the total belt length, without the need for cutting and patching the belt or using a belt storage device. Thus, the belt can be moved with essentially no stopping of production. Other advantages of this arrangement are that the Lo Lo belt does not have to be the same width as the main belt. Also, since the Lo Lo belt is separate, it is not necessary to align the Lo Lo exactly with the main belt. An inexact alignment can cause damage to the main belt. Further, the use of the Lo Lo means that the main belt needs to be extended less often which produces fewer splices in the belt.

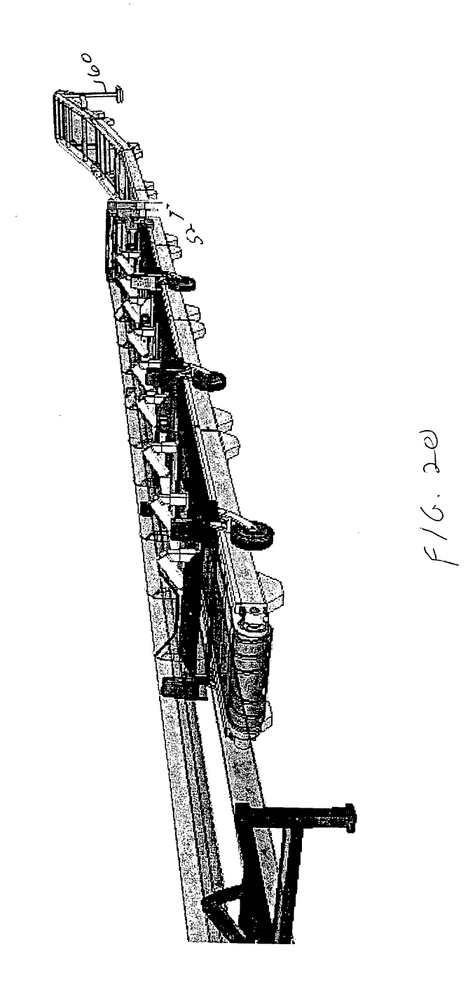

FIG. 14 shows a further arrangement based on the arrangement of FIG. 13. The Lo Lo structure 42 is arranged similarly to extend under car 10 which may be extendible or not extendible. Rollers 54 and 55 are part of the head drive and continue to carry a belt that forms a complete loop over the Lo Lo structure as well as these two rollers. Tail roller 53 is also seen at the front end of the framework 42. The main belt extends along roller sets 24 on car 10 and extends around tail roller 53. This roller is mounted on the same head drive unit 48. However, this roller is not associated with the belt on the Lo Lo structure but instead is the end roller of the main belt. A stacker unit 51 extends between roller 55 and roller 53 in order to further raise the material carried by the Lo Lo conveyor and to place it onto the main conveyor. The stacker includes an intermediate belt which can be separately powered, powered by the same drive as rollers 54 and 55 or may have an arrangement whereby power is derived from one of the other rollers. By mounting roller 53 and stacker 51 on the same framework as rollers 54 and 55, the belts are kept together so they not separate during an extension operation. Also, the head drive can be moved slightly to tighten the main belt. FIG. 19 shows a similar arrangement with the belt in place.

In operation, the Lo Lo belt begins at the end nearest the mine face and is carried on roller sets on the crosspieces between the side rails. No matter where the head drive is located along the rails, the conveyor travels over the two rollers as shown in FIG. 13. The conveyor continues on the rollers on the crosspieces until it reaches the end of the Lo Lo structure under the extendible cars. The conveyor belt is returned underneath the Lo Lo by contacting rollers on the bottom of the crosspieces. Accordingly, coal from the mining machines is received on the forward end of the Lo Lo and is carried by the conveyor until it is elevated by the head drive and carried onto the forward end of the car 10, which may be extendible or non-extendible. The conveyor then returns along the bottom of the Lo Lo.

As shown in FIG. 14, the head drive includes jacks 52, which may be extended into contact with the floor and roof of the mine. Separate jacks may be used for the floor and roof. More than one jack can be used in each direction. When it is desired to move the mining machine forward, the Lo Lo frame may be pulled forward along with the mining machine itself. Since the head drive is able to slide along the side rails of the frame of the Lo Lo structure, it is only necessary for the jacks 52 to contact the floor and roof so that the head drive is held in position near the main conveyor while the framework is advanced forwardly. Thus, the head drive is held in relationship to the car merely by actuating these jacks. The jacks also maintain proper alignment as the Lo Lo advances. The mining machine may pull the Lo Lo structure forward until the rear end reaches the forward end of the first car. Thus, it is possible to move the mining machine as far as the length of the Lo Lo without stopping the main conveyor, cutting the belt, or needing any further adjustments other than extending the jacks 52. When the jacks are released, the head drive automatically locks onto the frame using the tramming system to keep the belt tight.

While this arrangement is shown with the extendible cars, it is also possible that the Lo Lo structure could be utilized with a fixed conveyor system or non-extendible car as long as the profile of the Lo Lo can be inserted below the framework for the conveyor. Of course, this arrangement can also be used with any combination of cars and fixed belts as desired.

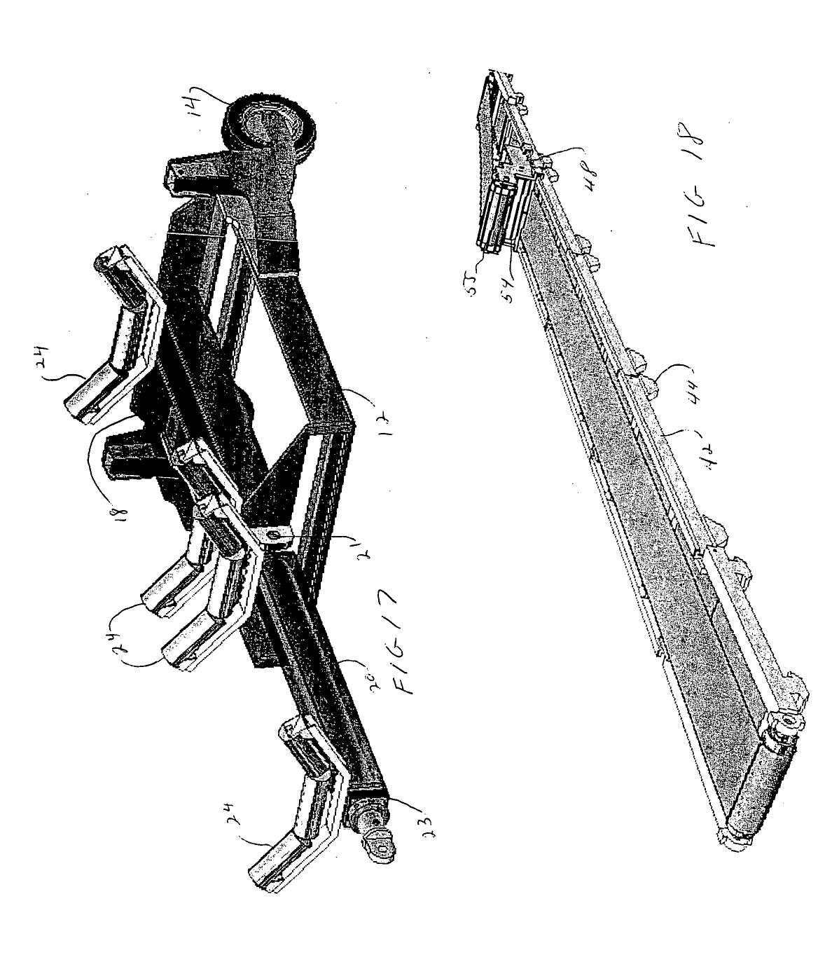

FIG. 15 shows another arrangement of using the Lo Lo structure. In this arrangement, the Lo Lo is parallel to the extendible cars. It could also be perpendicular or at an angle. The Lo Lo can still be advanced in the same manner and the head can be moved along the side rails in the same manner as discussed above. However, the coal is carried transversely off the head drive and onto the extendible cars which are placed parallel to the Lo Lo. This type of arrangement may be especially useful where it is not possible to elevate the cars to a height which would allow the Lo Lo to pass underneath.

While the Lo Lo structure has been described in terms of an arrangement with the extendible cars or a fixed main conveyor, it would also be possible to use it to start a secondary belt line rather than using a secondary conveyor head drive. It would also be possible to use the Lo Lo structure to load the coal on to an independent transportation method such as mine cars, which then may be carried to a conveyor or can be used independently. Likewise, other arrangements can be envisioned.

As pointed out above, an advantage of the system is that the main conveyor has less down time than in previous arrangements. The use of the Lo Lo arrangement does not require the main conveyor to stop at all. In addition to using the Lo Lo arrangement, it is also possible to use extendible cars which further does not require a stoppage in the belt since the extendible cars can be used in conjunction with a belt storage unit to obtain a further extension. Thus, the combination of the Lo Lo arrangement and the extendible cars allows for a considerable extension of the main conveyor without stopping. A permanent extension can be installed at a more convenient time.

The mechanism has been described as being utilized at the mining end of the conveyor used in the coal mine. However, this arrangement can be used in other situations. For example, after the coal is sorted, the refuse, which includes stones and other undesired materials, must be removed to a pile away from the sorting equipment. It is desirable to use a conveyor system to carry the refuse to the pile and to spread it. Using a fixed conveyor would require that the conveyor be moved when the pile becomes too large in one particular location. The present arrangement can be utilized to spread the refuse along the pile using the same arrangement in reverse. That is, the Lo Lo structure may be used to spread the refuse at the end of the main conveyor and may be moved forward and backward by extending it under the main conveyor. In this case, the refuse is dumped on the conveyor of the Lo Lo from the main conveyor. A head drive is not needed and the refuse is elevated by longer front legs and dumped onto the pile at various locations. It is possible to offload the material along the length of the frame as desired by moving the framework. When it is desired to move the frame, jacks that extend into the ground can be utilized to hold the rear end of the Lo Lo frame in position as necessary. Extendible cars could be included in the main belt for further extension if desired. Rotating wheels as shown in FIGS. 9 and 10 could be useful for moving the belt also.

FIG. 16 shows such an arrangement with the Lo Lo conveyor belt receiving the refuse from the main conveyor. The main conveyor may include cars 10 as desired. If desired, the Lo Lo structure may have an independent stacker structure mounted in its forward end so that the Lo Lo frame may be moved forward and backward with the stacker structure moving therewith so that the material is spread as desired. The forward end of the Lo Lo may be raised as shown to increase the height of the refuse pile. Longer legs or other structure to increase its height may replace skids 44. FIG. 20 shows a similar arrangement with longer front legs 60 and jacks 52 to hold the belt in position.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

In the claims:

1. A car for expanding a conveyor belt, comprising:
a frame;
a plurality of wheels connected to the frame;
a plurality of conveyor supports mounted on said frame for carrying a conveyor belt; and
an extendible member attached to said frame and carrying at least one of said conveyor supports thereon which selectively extends in the longitudinal direction of the conveyor to extend the conveyor length.

2. The car according to claim 1, wherein the extendible member is a central shaft.

3. The car according to claim 1, wherein the extendible member has an extended length roughly twice the unextended length.

4. The car according to claim 1, wherein the frame is approximately half the length of the car in an unextended state.

5. The car according to claim 1, wherein the frame is the full length of the car in an unextended state.

6. The car according to claim 1, wherein the extending member includes two sections each having an extending portion.

7. A method of extending a conveyor belt, comprising:
providing a plurality of conveyor belt supports for carrying said conveyor belt;
providing at least one car for carrying at least one of said conveyor supports;
separating said conveyor belt at at least one location;
extending a portion of said car and said at least one conveyor support in the longitudinal direction of said conveyor; and
adding additional length to said conveyor belt equivalent to the length of extension of said car.

8. A method of extending a conveyor belt, comprising:
providing a plurality of conveyor belt supports for carrying said conveyor belt;
providing at least one car for carrying at least one of said conveyor supports;
extending a portion of said car and said at least one conveyor support in the longitudinal direction of said conveyor; and
adding additional length to said conveyor belt equivalent to the length of extension of said car from a belt storage unit.

9. A conveyor system having a variable length comprising:
a plurality of fixed supports;
at least one car having at least one movable support;
a conveyor belt extending across and being carried by said fixed and movable conveyor supports;
said at least one car having a wheeled framework for supporting said movable conveyor support and an extendible portion mounted on said wheeled framework for moving said movable conveyor support in the longitudinal direction of said conveyor belt in order to lengthen the conveyor system.

10. A system according to claim 9, wherein a plurality of cars are included in said system.

11. A system according to claim 9, wherein the extendible portion includes a hollow main shaft and an extending shaft of smaller diameter mounted within said main shaft and wherein said extension shaft is removed from inside said main shaft in order to extend the length of the conveyor belt.

12. The system according to claim 11, further comprising a power source mounted on said car for moving said extension shaft.

13. The system according to claim 9, wherein said extendible member is pivoted to allow the movable conveyor supports to move in a vertical plane to adjust the height of the conveyor belt.

14. A wheel assembly for a car in a conveyor belt system, comprising:
a wheel attached to said car;
an elevating assembly for adjusting the relative positions of said wheel and said car to cause said car to be elevated;
a rotating assembly connected between said wheel and said car for allowing said wheel to be rotated about a vertical axis so as to allow said car to be moved in a different direction.

15. The wheel assembly according to claim 14, further comprising a locking arrangement for holding said rotation arrangement at a set position.

16. The wheel assembly according to claim 14, wherein the elevating assembly includes a hydraulic cylinder.

17. The wheel assembly according to claim 14, wherein said rotational assembly includes a vertically oriented shaft fixedly connected to said car and a rotating hollow cylindrical shaft mounted there around for rotating said wheel.

18. A low profile conveyor system comprising:
a framework located near the ground;
a plurality of dollies mounted on said framework for movement thereon;
a plurality of first conveyor supports mounted on said dollies;
a plurality of second conveyor supports mounted on a structure other than said dollies;
a conveyor belt being placed on said first and said second conveyor supports; and
a conveyor drive for causing said belt to move;
said framework being mounted below said structure and being movable in relation therewith so as to extend the length of said conveyor belt.

19. The conveyor according to claim 18, wherein the structure includes cars having conveyor supports on an extendible section for extending the length of the conveyor belt.

20. The low profile conveyor according to claim 19, wherein the extendible portion of said cars is attached to at least one of said dollies to adjust the position of said dolly on said framework.

21. A low profile conveyor system comprising:
a framework near the ground;
a plurality of conveyor supports mounted on said framework for carrying a conveyor belt to form a first conveyor; and
an elevating section for increasing the height of the conveyor belt, the elevating section being movable upon said framework;
wherein said first conveyor operates in conjunction with a separate second conveyor and is mounted below said second conveyor so as to be movable in the longitudinal direction relative to the second conveyor to extend said conveyor system.

22. The low profile conveyor system according to claim 21, wherein the elevating portion remains fixed in position when said framework extends longitudinally to extend the conveyor.

23. The low profile conveyor system according to claim 22, wherein jacks are provided at said elevating portion positions to prevent movement thereof.

24. The low profile conveyor system according to claim 21, wherein the second conveyor includes at least one extendible car.

25. The low profile conveyor system according to claim 21, wherein the second conveyor is a main conveyor belt having a fixed portion and at least one extendible car where the first conveyor extends below the car so that the car may be extended in addition to the extension of the system by moving the low profile conveyor longitudinally.

26. The low profile conveyor system according to claim 21, wherein said second conveyor is horizontally displaced but parallel to said low profile conveyor.

27. A method for extending a conveyor belt, comprising:
providing a first conveyor belt;
providing a second conveyor belt having a low profile;
placing said second conveyor belt below said first conveyor belt so as to be parallel therewith;
longitudinally moving said second conveyor belt from beneath said first conveyor belt in order to extend a total belt length.

28. The method according to claim 27, wherein the second conveyor belt is a low profile conveyor belt.

29. The method according to claim 27, wherein the said second conveyor belt includes an elevating portion for increasing the height of the second conveyor belt so as to move products from said second conveyor belt onto said first conveyor.

30. The method according to claim 29, wherein said elevating portion is movable along a framework of said second conveyor belt.

31. The method according to claim 27, wherein said first conveyor belt is extendible by including an extendible car having an extendible portion therewith.

32. A conveyor system for spreading material in a pile, comprising:
a main belt;
a low profile belt operating in conjunction with said main belt; and
said low profile belt extending below said main belt so as to be extendible therefrom to move material to different locations.

33. The conveyor system according to claim 32, wherein the main conveyor belt includes extendible cars for extending the main conveyor belt.

34. The conveyor belt system according to claim 32, wherein the belt carries refuse from a mine onto a refuse pile.
